(19) United States
(12) Patent Application Publication
(10) Pub. No.: US 2026/0227789 A1
(43) Pub. Date: Aug. 6, 2026

(54) Method for Preventing Traversal of Unsensed Areas for an Autonomous Work Vehicle

(71) Applicant: Autonomous Solutions, Inc., Mendon, UT (US)

(72) Inventors: Taylor Bybee, Mendon, UT (US); Mckay Colleni, Mendon, UT (US); Chui Vanfleet, Mendon, UT (US)

(73) Assignee: Autonomous Solutions, Inc., Mendon, UT (US)

(21) Appl. No.: 19/287,797

(22) Filed: Jul. 31, 2025

Related U.S. Application Data
(60) Provisional application No. 63/753,938, filed on Feb. 4, 2025.

(51) Int. Cl. G05D 1/622; A01B 69/04; G05D 1/246; G05D 1/65; G05D 105/15; G05D 107/20; G05D 109/10; G05D 111/10

(52) U.S. Cl. CPC G05D 1/622; A01B 69/008; G05D 1/2464; G05D 1/65; G05D 2105/15; G05D 2107/21; G05D 2109/10; G05D 2111/17

(57) ABSTRACT

Disclosed are autonomous vehicles, systems, and methods that rely on the fusing of primary and secondary sensor signal data for navigating an autonomous vehicle. The primary sensor may have greater detection capabilities than the secondary sensor, such as a primary sensor comprising a 3D LiDAR sensor and a secondary sensor comprising a 2D LiDAR sensor. The autonomous vehicle may rely on the primary sensor signal data to the exclusion of at least some of the secondary sensor signal data. The autonomous vehicle may prioritize the primary sensor signal data whenever the secondary sensor signal data conflicts with the primary sensor signal data. In some embodiments, the secondary sensor signal data may be used to increase, but not decrease, an occupancy probability of a cell used to navigate the autonomous vehicle. In some embodiments, the secondary sensor signal data may be scaled and adjusted with the primary sensor signal data.

### BACKGROUND

For safe navigation through an operating environment, autonomous ground vehicles rely on sensory inputs such as cameras, LiDAR, and radar for detection and classification of obstacles and impassable terrain. These sensors provide data representing 3D space surrounding the vehicle. Some sensors may comprise greater capability than other sensors for detecting obstacles within the operating environment. Decisions regarding which kinds of sensors to use may form an important consideration in developing an optimal composite sensor field of view for navigating the autonomous vehicle.

### SUMMARY

Disclosed are autonomous vehicles, and systems and methods for navigating autonomous vehicles, by fusing and/or prioritizing primary and secondary signal data. An autonomous vehicle may comprise a steering control system, a speed control system, and one or more sensors, including a primary sensor and a secondary sensor. The autonomous vehicle may also comprise one or more processors communicatively coupled with the one or more sensors, the steering control system, and the speed control system, and one or more computer-readable media having stored thereon instructions for navigating the autonomous vehicle. The instructions may cause the processors to receive primary signal data from the primary sensor, receive secondary signal data from the secondary sensor, and calculate an occupancy probability of a cell of a plurality of cells within an occupancy probability map based on the primary signal data and the secondary signal data. The occupancy probability map may represent a sensor field of view within an operating environment. Calculating the occupancy probability of the cell may include: when the primary signal data indicate presence of an obstacle in the cell, increasing the occupancy probability of the cell; when the secondary signal data indicate presence of an obstacle in the cell, increasing the occupancy probability of the cell; when the primary signal data does not indicate presence of an obstacle in the cell, decreasing the occupancy probability of the cell; and when the secondary signal data does not indicate presence of an obstacle in the cell, not decreasing the occupancy probability of the cell. The instructions may further include instructing the steering control system and the speed control system to drive the autonomous vehicle along a path through an area in the operating environment based on the occupancy probability of the cell.

The primary sensor may have a greater detection capability than the secondary sensor. For example, the primary sensor may be a 3D LiDAR sensor and the secondary sensor may be a 2D LiDAR sensor. The one of the one or more sensors (including the primary and/or secondary sensors) may comprise a LiDAR, depth camera, structure light camera, a stereo camera, or a radar sensor.

The primary sensor may be positioned at a front of the autonomous vehicle and the secondary sensor may be positioned at a side or rear of the autonomous vehicle. The secondary sensor may be positioned towards a bottom of the autonomous vehicle relative to the primary sensor. The autonomous vehicle can comprise two, three, four, five, six, seven, eight, or more than eight secondary sensors. The primary sensor and the secondary sensor may have overlapping fields of view.

The autonomous vehicle may comprise a steering mechanism in communication with the one or more processors, wherein the one or more processors may communicate steering commands to the steering mechanism based on an occupancy probability of the cell. The autonomous vehicle may comprise a braking mechanism in communication with the one or more processors, wherein the one or more processors may communicate braking commands to the braking mechanism based on an occupancy probability of the cell.

Also disclosed are methods for navigating an autonomous vehicle. The method may comprise receiving primary signal data from a primary sensor, receiving secondary signal data from a secondary sensor, and calculating an occupancy probability of a cell of a plurality of cells within an occupancy probability map based on the primary signal data and the secondary signal data. The occupancy probability map may represent a sensor field of view within the operating environment. Calculating the occupancy probability of the cell may include: when the primary signal data indicate presence of an obstacle in the cell, increasing the occupancy probability of the cell; when the secondary signal data indicate presence of an obstacle in the cell, increasing the occupancy probability of the cell; when the primary signal data does not indicate presence of an obstacle in the cell, decreasing the occupancy probability of the cell; and when the secondary signal data does not indicate presence of an obstacle in the cell, not decreasing the occupancy probability of the cell. The method may then include instructing a steering control system and a speed control system to drive the autonomous vehicle along a path through an area in the operating environment based on the occupancy probability of the cell.

An autonomous vehicle comprising a steering control system, a speed control system, one or more sensors, including a primary sensor and a secondary sensor, one or more processors communicatively coupled with the one or more sensors, the steering control system, and the speed control system, and one or more computer-readable media having stored thereon instructions that when executed by the one or more processors receive primary signal data from the primary sensor, receive secondary signal data from the secondary sensor, when the secondary signal data conflicts with the primary signal data, calculate an occupancy probability of a cell of a plurality of cells within an occupancy probability map, wherein the occupancy probability map represents a sensor field of view within an operating environment, based on the primary signal data but not the secondary signal data, and instruct the steering control system and the speed control system to drive the autonomous vehicle along a path through an area in the operating environment based on the occupancy probability of the cell.

These illustrative embodiments are mentioned not to limit or define the disclosure, but to provide examples to aid understanding. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying Drawings. In the Drawings, like reference numerals may be utilized to designate corresponding or similar parts in the various Figures, and the various elements depicted are not necessarily drawn to scale, wherein:

FIG. 1 illustrates an example of an autonomous vehicle.

FIG. 2 illustrates the range of a 3D LiDAR sensor and a 2D LiDAR sensor positioned at the front and towards the bottom of the autonomous tractor, respectively.

FIG. 3 shows an autonomous vehicle wherein the 3D LiDAR and 2D LiDAR sensors correctly identify an obstacle.

FIG. 4 shows an autonomous vehicle wherein the 2D LiDAR sensor, but not the 3D LiDAR sensor, falsely identifies an obstacle over undulating terrain.

FIG. 5 illustrates an autonomous vehicle wherein the 3D LiDAR sensor, but not the 2D LiDAR sensor, correctly identifies an obstacle.

FIG. 6 shows an autonomous vehicle wherein the 3D LiDAR sensor, but not the 2D LiDAR sensor, correctly identifies an obstacle over undulating terrain.

FIG. 7 illustrates an autonomous vehicle wherein the 2D LiDAR sensor, but not the 3D LiDAR sensor, falsely identifies an obstacle over undulating terrain.

FIG. 8A-8B show an aerial view of an autonomous vehicle during navigation of an environment wherein an obstacle is within the sensor field of view.

FIG. 9A-9B illustrates an aerial view of an autonomous vehicle during navigation of an environment wherein an obstacle is within the sensor field of view.

FIG. 10 shows an illustrative computational system for performing functionality to facilitate implementation of embodiments described in this document.

FIG. 11 illustrates a block diagram of an example autonomous vehicle communication system of the present disclosure.

FIG. 12 is a side view of an autonomous yard truck according to some embodiments.

FIG. 13 is a perspective view of an autonomous mower according to some embodiments.

FIG. 14 is a side view of an autonomous tractor according to some embodiments.

### DETAILED DESCRIPTION

Autonomous vehicle systems rely on exteroceptive sensors to navigate an environment. For example, 2D or 3D scanning technologies can be used to generate a point cloud map or other representation of a sensor field of view within an operating environment. Conventionally, autonomous vehicles may support multiple sensors distributed about the vehicle for mapping the environment in which the vehicle operates. For example, an autonomous vehicle may have sensors positioned at the front, sides, and/or rear of the vehicle.

The various sensors may differ in their capability to perceive and/or map the operating environment. More capable sensors may be positioned on the autonomous vehicle towards directions where mapping is critical. For example, more capable sensors may be positioned on the autonomous vehicle closer to the direction in which the autonomous vehicle typically drives (e.g., towards the front of the autonomous vehicle), while less capable sensors may be positioned towards other directions (e.g., towards the sides and/or rear of the autonomous vehicle).

Some systems employ more capable sensors at multiple positions along the autonomous vehicle. However, more capable sensors may differ greatly in cost when compared to less capable sensors. For example, 3D LiDAR sensors may cost thousands of dollars while 2D LiDAR sensor may cost only hundreds of dollars. Less capable sensors can supplement mapping of the operating environment while maintaining vehicular safety and efficiency. Employing more capable sensors in conjunction with less capable sensors may then enable effective navigation of the autonomous vehicle without adopting unacceptable levels of safety.

However, navigation discrepancies may arise when signal data from the more and less capable sensors conflict. For example, more capable sensors may detect obstacles in the environment while less capable fail to detect the obstacle. Alternatively, signal data from the less capable sensors may indicate the presence of an obstacle while more capable sensors may produce signal data that does not indicate the presence of an obstacle. These situations may induce difficulty in resolving the conflict and in determining how to select which signal data on which to rely.

Disclosed herein are autonomous vehicles, autonomous vehicle systems, and methods for integrating and/or fusing the signal data obtained from more and less capable sensors to better identify obstacles in the operating environment. The method may comprise receiving signal data from primary and secondary sensors and then calculating an occupancy probability associated with a location within the operating environment based on the signal data. The autonomous vehicle system may prioritize signal data from the primary sensor over signal data from the secondary sensor. For example, when secondary signal data from the secondary signal conflicts with primary signal data from the primary sensor, changes to the occupancy probability may not be based on the secondary signal data.

Alternatively, or additionally, the occlusion probability may be increased and/or decreased based on the primary signal data but may only be increased based on the secondary signal data, such that secondary signal data may only be used to confirm the presence of an obstacle, but not the absence of an obstacle. In another embodiment, a master occupancy probability may be set based on two sub-components: a first occupancy probability and a second occupancy probability. The first occupancy probability may be increased and/or decreased based on the primary signal data. The second occupancy probability may be increased and/or decreased based on the secondary signal data and may be decreased based on the primary signal data. The second occupancy probability may be decreased based on a scalar of the primary signal data. The master occupancy probability may then be set as the greater of the first and second occupancy probabilities. The autonomous vehicle may then be driven based on the master occupancy probability.

The above may enable the autonomous vehicle to better detect obstacles within the operating environment and resolve conflicting data between more and less capable sensors. These methods, vehicles, and systems may thus enable safer and more efficient navigation of the autonomous vehicle within an operating environment.

As used herein, a “primary sensor” may refer to a sensor that is more capable than a “secondary sensor”. When compared to the secondary sensor, the primary sensor may have a larger field of view (e.g., wider view, greater viewing angle, wider aperture) or a larger detection range, may collect data in more planes, may collect data at a higher collection density rate, or may otherwise have greater capacity along at least one parameter when compared with the secondary sensor. For example, the primary sensor may comprise a 3D LiDAR sensor and the secondary sensor may comprise a 2D LiDAR sensor. In another example, the primary sensor may comprise a 3D LiDAR sensor and the secondary sensor may comprise a camera image. In another example, the primary sensor may comprise a 2D LiDAR sensor and the secondary sensor may comprise a radar sensor.

An obstacle may be defined as a phenomenon present in the environment that may interfere with the safe operation of the autonomous vehicle. Although obstacles may often effectively occlude the sensor field of view, not all obstacles are occlusions. An obstacle may also comprise an object that might damage the autonomous vehicle upon impact, but to which minimal damage or harm may be desired. Obstacles may include ‘positive obstacles’ the may include objects present in the environment, such as trees, rocks, fencing, infrastructure, as well as people (e.g., adults or children), animals, or other vehicles. Obstacles may also include ‘negative obstacles’ comprising negative space, such as a cliff, rapid decline, or drop-off present in the operating environment.

The sensor field of view within the operating environment may be represented by an occupancy probability map. The occupancy probability map may comprise a grid of a plurality of cells, with each cell pertaining to a location within the sensor field of view. Each cell may contain an occupancy probability value that represents the probability that an obstacle is present within the sensor view at the location associated with the cell.

Signal data generated by the one or more sensors may indicate the presence or absence of an obstacle and which may be used to set the occupancy probability of the cell. The signal data may comprise true positive and negative data, such that the signal data correctly indicates the presence or absence of an obstacle, respectively. Alternatively, or additionally, the signal data may comprise false positive and negative data, such that the signal data incorrectly indicates the presence or absence of an obstacle, respectively. False positive and/or negative data may present a principal source of conflict between primary and secondary signal data.

In some embodiments, point cloud data generated from an autonomous vehicle by a 3D LiDAR, structured light, or stereo camera system (or any other system) may include information about the objects within a field of view. Due to the distribution of the points in each point cloud, for example, the current sensor field of view may be inferred. If the current sensor field of view does not match an ideal sensor field of view, it may, for example, indicate that something (e.g., an obstacle) may be occluding the sensor. Some embodiments include algorithms, processes, methods, or systems that model the probability of occupancy in a map by incorporating an ideal sensor field of view model compared against signal data over time.

In some embodiments, an occupancy mapping algorithm may model an area around an autonomous vehicle as a grid map where each grid cell represents the probability of occupancy from one or more sensors mounted on the vehicle. This can be an occupancy probability map that may be updated regularly. Updating the occupancy probability map may require knowledge of the sensor field of view (FOV), which may be represented as a probability mass function centered around the vehicle.

The occupancy probability values may be initialized to a value corresponding to the presence of an obstacle. That is, the occupancy probability of a cell may be set as a default to indicate that an obstacle is present at the location of the cell and may be decreased based on signal data received from the one or more sensors of the autonomous vehicle. Alternatively, the occupancy probability values may be initialized to a value corresponding to absence of an obstacle or to an intermediate value that corresponds to uncertainty about the presence or absence of an obstacle (e.g., a value corresponding to an unknown state). The occupancy probability of the above cells may be initialized at the beginning of the vehicle operation, after a pause in the operation, or at any time based on input from a remote operator.

The autonomous vehicle system may comprise one or more sensors that collect signal data from the operating environment. The signal data may be signal data pertaining to at least a subset of cells within the plurality of cells and may represent that the location(s) associated with the subset of cells contains or lacks an obstacle. The signal data may comprise data received from a 3D LiDAR sensor, a 2D LiDAR sensor, or other sensor of the autonomous vehicle.

When the signal data is received, the occupancy probability of the subset of cells may be set to a value indicating the presence or absence of an obstacle. Thereafter, the sub-systems of the autonomous vehicle (e.g., steering and/or speed control systems disclosed below) may drive the autonomous vehicle along a path through an area in the environment, including those areas associated with the subset of cells pertaining to the observed signal data. Paths generated for navigating the autonomous vehicle containing the subset of cells may be excluded in favor of paths that do not contain the subset of cells.

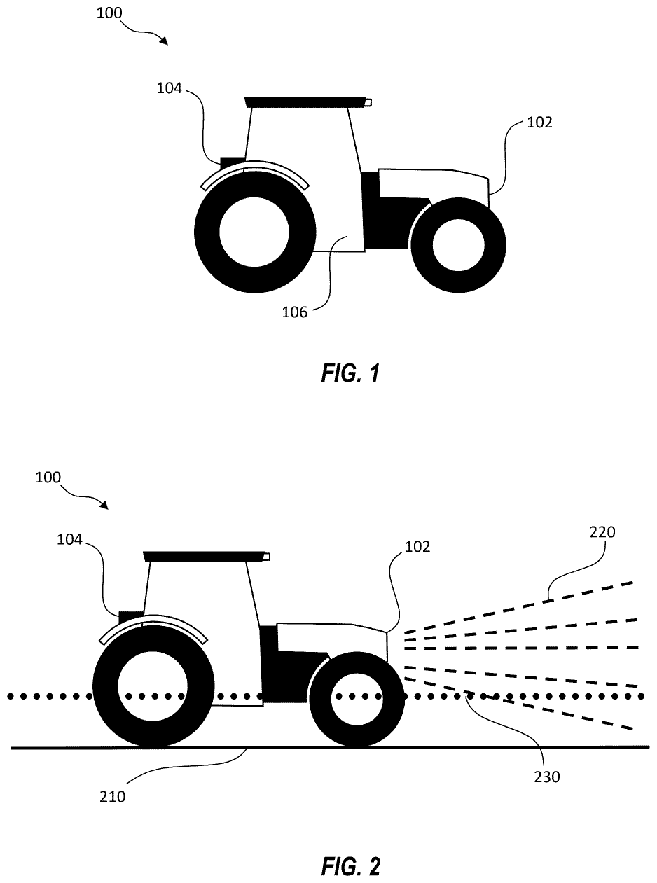

FIG. 1 illustrates an example autonomous vehicle 100, such as an autonomous tractor as shown. The autonomous vehicle 100 may comprise any type of autonomous vehicle, such as, those discussed more fully below. One or more sensors may be disposed over the body of the autonomous vehicle 100, such as at the front 102, the rear 104, or the sides 106 of the autonomous vehicle 100.

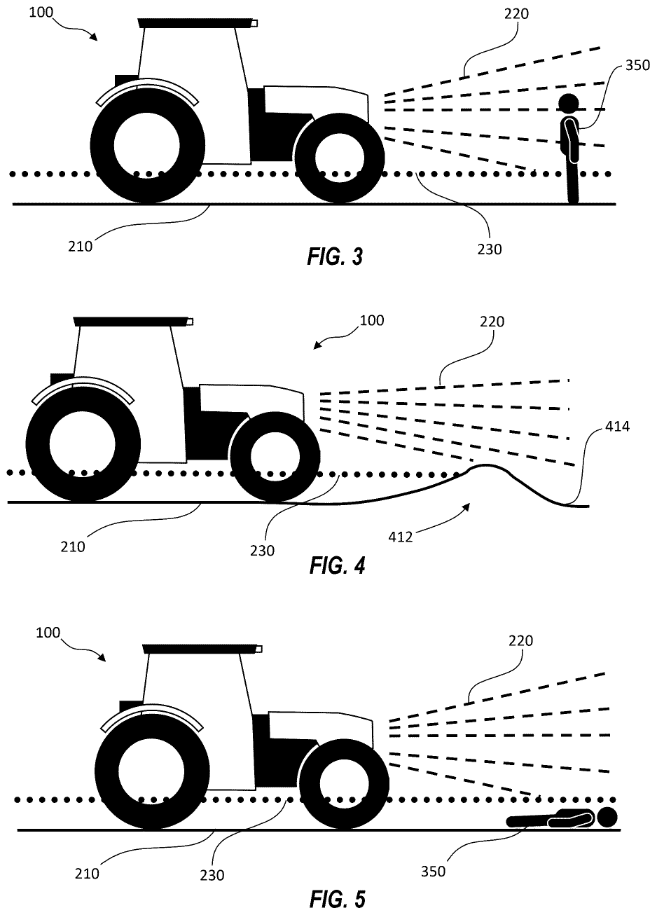

FIG. 2 shows the autonomous vehicle 100 positioned upon a surface 210 within an operating environment. Also shown are the sensor field of view (FOV), including a primary sensor FOV 220 and a secondary sensor FOV 230. The primary sensor may have a greater detection capability than the secondary sensor. In the example shown, and the examples that follow in FIGS. 3-9B, the primary sensor FOV 220 is shown as having a 3D data collection capability, and collecting data in more planes than, the secondary sensor FOV 230, which in this example collects data in only a single plane. For example, the primary sensor may comprise a 3D LiDAR sensor and the secondary sensor may comprise a 2D LiDAR sensor. However, one skilled in the art will understand that the primary and secondary sensors may comprise other sensors, including a LiDAR (2D or 3D), depth camera, structure light camera, a stereo camera, or a radar sensor.

The primary sensor may be located towards a direction in which the autonomous vehicle 100 usually proceeds. For example, the primary sensor may be located towards the front 102 of the autonomous vehicle 100, such that the primary sensor FOV 220 extends in front of the autonomous vehicle 100. The secondary sensor may then be located towards the rear 104 and/or sides 106 of the autonomous vehicle 100 such that the secondary sensor FOV 230 extends behind or to the side of the autonomous vehicle 100. In this manner, the primary sensor may collect signal data in the primary moving direction (i.e., in the forwards-proceeding direction) during a majority of vehicular movement, whereas the secondary sensor may collect signal data in other moving directions and may be particularly useful, for example, when the autonomous vehicle is moving in reverse. However, in some embodiments, the primary and secondary sensors may be located at different portions of the autonomous vehicle. For example, the secondary sensor may be disposed at the front 102 of the autonomous vehicle 100 and the primary sensor may be disposed at the rear 104 and/or sides 106 of the autonomous vehicle 100.

The autonomous vehicle 100 may comprise multiple secondary sensors. For example, the autonomous vehicle 100 may comprise two, three, four, five, six, seven, eight, or more than eight secondary sensors. The multiple secondary sensors may be disposed at different locations along the autonomous vehicle 100, such as at the front 102, rear 104, and sides 106. The secondary sensors may also be disposed towards the bottom of the autonomous vehicle, which may produce a planar secondary sensor FOV 230 towards the bottom of the vehicle 100 (as shown in FIG. 2). This may enable the secondary sensor detect more obstacles within the operating environment. Additionally, or alternatively, a secondary sensor may be disposed towards the top of the autonomous vehicle 100. Similarly, the autonomous vehicle 100 may comprise multiple primary sensors, which may be disposed about the body of the autonomous vehicle 100.

In some embodiments, such as that shown in FIG. 2, the secondary sensor may be positioned towards a bottom of the autonomous vehicle 100 relative to the primary sensor. This may be the case when the primary sensor FOV 220 collects signal data in more planes than the secondary sensor FOV 230.

The secondary sensor(s) may act principally to confirm and/or validate information obtained by the primary sensor and/or to view portions of the operating environment not observable by the primary sensor FOV 220. However, in some embodiments, the primary sensor FOV 220 and the secondary sensor FOV 230 may overlap, such that the primary sensor FOV 220 and the secondary sensor FOV 230 extend over the same portions of the operating environment simultaneously.

With regard to FIG. 2, the secondary sensor may be oriented such that the planar secondary sensor FOV 230 extends parallel to a longitudinal axis of the autonomous vehicle 100 or parallel to the surface 210 of the operating environment. This may enable the secondary sensor FOV 230 to extend to the furthest extent to maximize the view of the secondary sensor. However, the planar secondary sensor FOV 230 may be limited, especially when compared to the multi-planar primary sensor FOV 220. Although the secondary sensor FOV 230 is shown as extending both behind and in front of the autonomous vehicle 100, it may be the case that the secondary sensor FOV 230 extends only in one of those directions or in neither of those directions (such as toward the rear of the autonomous vehicle only).

FIG. 3 illustrates an obstacle 350 (specifically an adult or child) as it interacts with both the primary and secondary sensor FOVs 220, 230. As shown, the primary and secondary sensor FOVs 220, 230 both intersect the obstacle 350, such that the primary and secondary sensors collect signal data indicating the presence of an obstacle 350 within the sensor FOVs 220, 230.

FIGS. 4 and 5 more particularly illustrate the possible limitations of the secondary sensor relative to the primary sensor. FIG. 4 illustrates the autonomous vehicle 100 as it navigates undulating terrain of the operating environment surface 210. The undulating terrain may comprise a mound 412 which may not pose an obstacle to the safe and effective operation of the autonomous vehicle 100. However, the mound 412 may interact with the secondary sensor FOV 230, such that the secondary sensor may thereby collect signal data that indicates the presence of an obstacle, despite that the mound 412 does not present an obstacle to the vehicle 100.

In contrast, the primary sensor FOV 220 may contain both the mound 412 and more distant portions 414 of the operating environment. In this manner, the primary sensor may detect the mound 412 (e.g., detect the height of the mound) and effectively determine that the mound 412 does not present an obstacle to the autonomous vehicle 100.

FIG. 5 illustrates another situation in which an obstacle 350 (e.g., an adult or child) is lying on the surface 210 of the operating environment. In this instance, the obstacle 350 may lie below the plane of the secondary sensor FOV 230, such that the secondary sensor does not detect the obstacle 350. In contrast, the primary sensor FOV 220 may contain the obstacle 350, such that the obstacle 350 is detected by the primary sensor.

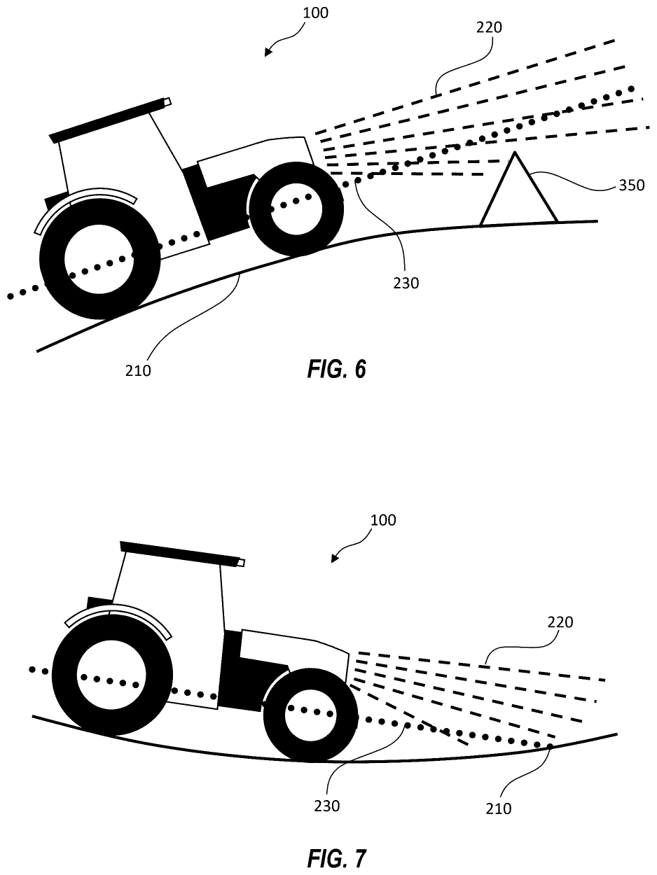

FIGS. 6 and 7 further illustrate the autonomous vehicle 100 as it navigates undulating terrain of the operating environment surface 210. FIG. 6 illustrates the autonomous vehicle 100 as it ascends a rise of the operating environment surface 210, which may cause the secondary sensor FOV 230 to angle upwards, such that the secondary sensor does not detect an obstacle 350 in front of the vehicle 100. In contrast, the primary sensor FOV 220 may continue to detect the obstacle 350 despite the change in undulating terrain.

FIG. 7 illustrates the autonomous vehicle 100 as it descends into a depression of the operating environment surface 210. In this instance, the secondary sensor FOV 230 may interact with the surface 210 of the operating environment, such that the secondary sensor may falsely indicate the presence of an obstacle. In contrast, the primary sensor FOV 220 may continuously examine the surface 210 of the operating environment (as the mutli-planar primary sensor FOV 220 may be directed, at least in part, towards the ground) and may thus correctly identify the depression as lacking an obstacle.

The above figures illustrate several ways in which the shape and orientation of an obstacle as well as the effects of undulating terrain may prevent less capable sensors from detecting obstacles while more capable sensors maintain detection. However, one skilled in the art will understand that there are other instances, environments, and parameters that may make obstacles difficult to detect in other situations for many types of sensors. The following methods may be employed in a similar manner despite the types and capabilities of the sensors, despite that the examples used employ planar (e.g., 2D LiDAR) and multi-planar (3D LiDAR) sensors.

Below are described methods for fusing the signal data collected by the primary and secondary sensors, and which may enable the navigation of the autonomous vehicle 100 when primary and secondary signal data conflict regarding the presence of an obstacle.

In a first method, an autonomous vehicle 100 may receive primary signal data from the primary sensor and may receive secondary signal data from the secondary sensor. The primary and secondary signal data may then be used to calculate an occupancy probability for a cell or a subset of cells of a plurality of cells within an occupancy probability map or grid. The occupancy probability map may represent a sensor field of view within the operating environment, including the primary and secondary FOVs 220, 230 as well as the field of view of other sensors disposed about the autonomous vehicle 100.

The primary signal data may provide information indicating the presence of an obstacle at a location in the operating environment associated with the cell or subset of cells of the occupancy probability map. Specifically, the primary signal data may indicate that an obstacle is present at the location associated with the cell or subset of cells or may indicate that no obstacle is present at the location associated with the cell or subset of cells. The secondary signal data may similarly indicate that an obstacle is or is not present at the location associated with the cell or subset of cells.

Calculation of the occupancy probability of the cell may be based on the primary and/or secondary signal data. The primary sensor, having a greater capability than the secondary sensor, may be treated as more reliable than the secondary sensor. In one embodiment, adjustment of the occupancy probability of the cell may be based on the detection of an obstacle within the signal data. Specifically, the primary signal data may be relied on to increase or decrease the occupancy probability (i.e., the primary signal data may be relied on to indicate the presence of an obstacle) whereas the secondary signal data may be relied on to increase the occupancy probability (i.e., to indicate the presence of an obstacle) but may not be relied on to decrease the occupancy probability (i.e., to indicate no presence of an obstacle).

That is, the method may comprise the following steps. When the primary signal data indicates the presence of an obstacle at the cell (i.e., at the location associated with the cell), the occupancy probability of the cell may be increased. When the primary signal data does not indicate the presence of an obstacle at the cell, the occupancy probability of the cell may be decreased. When the secondary signal indicates the presence of an obstacle at the cell, the occupancy probability of the cell may be increased. However, when the secondary signal does not indicate the presence of an obstacle at the cell, the occupancy probability of the cell may not be decreased. That is, although the occupancy probability of the cell may be decreased when the primary signal data does not indicate the presence of an obstacle at the cell, the occupancy probability of the cell may not be decreased when solely the secondary signal data does not indicate the presence of an obstacle at the cell. Such a method may enable the autonomous vehicle 100 to better detect an obstacle and may prevent false negatives in the secondary signal data from interfering with the safe operation of the autonomous vehicle 100.

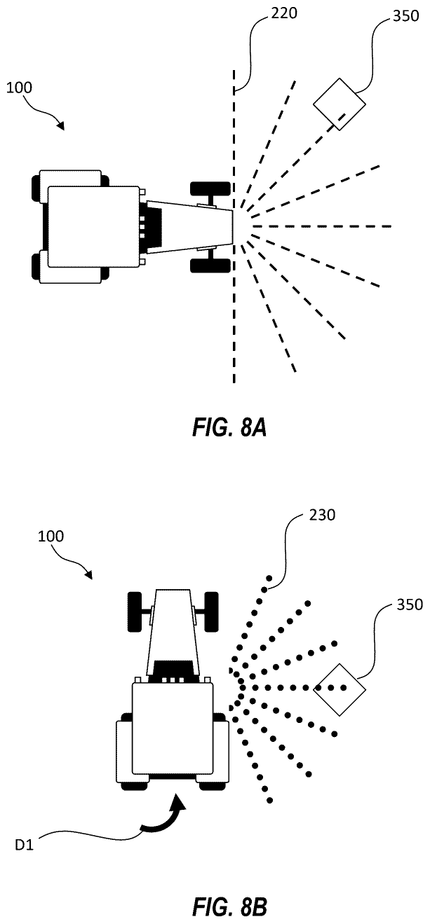

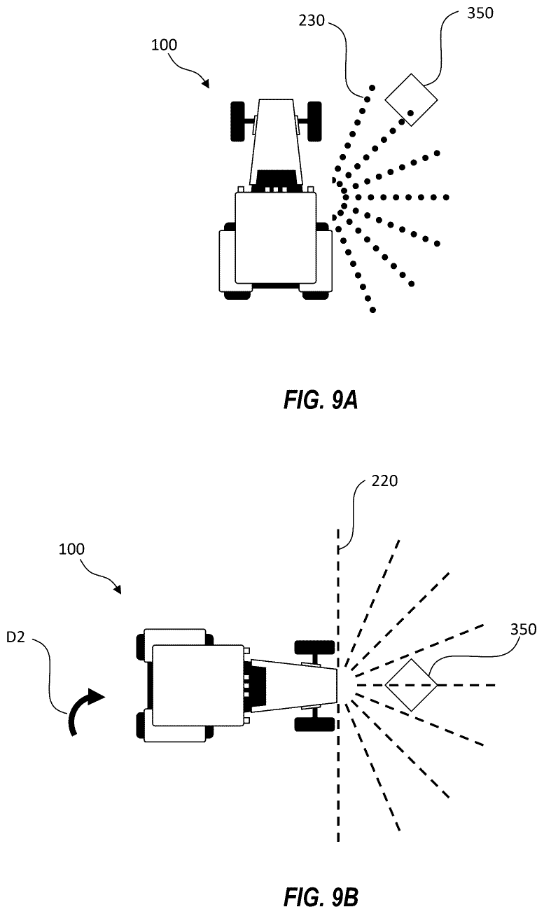

FIGS. 8A-9B illustrate an autonomous vehicle 100 as it navigates an operating environment with an obstacle 350 within the primary or secondary FOVs 220, 230. Specifically, FIGS. 8A-9B illustrate instances wherein an obstacle 350 is detected by the primary sensor but is not detected by the secondary sensor and further help to illustrate how an autonomous vehicle 100 may employ the above method (or those described in more detail below) to prioritize different types of signal data. Similarly, FIGS. 8A-9B illustrate autonomous vehicles 100 wherein the primary sensor is positioned towards the front of the autonomous vehicle 100 and the secondary sensor is positioned towards the side of the autonomous vehicle 100, although the primary and secondary sensors may be positioned towards different portions of the autonomous vehicle 100.

FIG. 8A illustrates the autonomous vehicle 100 wherein an obstacle 350 is present within the primary sensor FOV 220 but not the secondary sensor FOV 230. In this instance, when the obstacle 350 is detected within the primary sensor FOV 220, the primary signal data may be relied on to increase the occupancy probability of the cell associated with the location of the obstacle 350 within the operating environment.

FIG. 8B illustrates the autonomous vehicle 100 as it turns in direction D1. After performing the turn, the obstacle 350 may leave the primary sensor FOV 220 and enter the secondary sensor FOV 230. However, in this instance, the secondary sensor fails to detect the obstacle 350 (i.e., a false negative) within the operating environment. The autonomous vehicle system then does not decrease the occupancy probability of the cell because the occupancy probability was set earlier based on the primary signal data. It is important to note that subsequently when the location associated with the cell re-enters the primary sensor FOV 220 that the occupancy probability of the cell could be decreased based on the primary signal data (e.g., if the obstacle 350 has moved from its earlier position).

FIG. 9A illustrates the autonomous vehicle 100 when the obstacle 350 first enters the field of view of the one or more sensors, in this instance within the secondary sensor FOV 230 but not the primary sensor FOV 220. In this instance, the secondary sensor fails to detect the obstacle 350 within the operating environment and the occupancy probability of the cell associated with the location of the obstacle 350 may be decreased.

FIG. 9B shows the autonomous vehicle 100 as it turns in direction D2. After the autonomous vehicle performs the turn, the obstacle 350 may exit the secondary sensor FOV 230 and enter the primary sensor FOV 220. Because of its greater capability, the primary sensor may detect the obstacle 350 within the operating environment. The occupancy probability of the cell may then be increased as a result of receiving primary signal data from the primary sensor. The occupancy probability of the cell may still be increased, even when the obstacle 350 does not leave the secondary sensor FOV 230.

In another method for fusing the primary and secondary signal data, the primary and secondary signal data may be used to set occupancy probabilities of separate occupancy probability grids. For example, the method may use primary and secondary signal data to set occupancy probabilities in the cells of a first occupancy grid, a second occupancy grid, and a master occupancy grid, each grid representing a field of view of the autonomous vehicle sensors within the operating environment.

A first occupancy probability grid may contain a plurality of cells having an occupancy probability based only on the primary signal data. Primary signal data indicating the presence of an obstacle at a first cell (i.e., at a location associated with the first cell) may increase the occupancy probability of the first cell within the first occupancy probability grid and primary signal data that does not indicate the presence of an obstacle at the first cell may decrease the occupancy probability of the first cell.

The second occupancy probability grid may contain a plurality of cells having an occupancy probability based on the secondary signal data and the negative primary signal data (i.e., primary signal data that does not indicate presence of an obstacle at the cell). The second occupancy probability grid may have a same or similar number of cells as the first occupancy grid, such that the locations associated with the cells of the second occupancy grid correspond to the locations associated with the cells of the first occupancy probability grids. Secondary signal data indicating the presence of an obstacle at a second cell (i.e., at a location associated with the second cell and which may be the same location associated with the first cell) may increase the occupancy probability of a second cell within the second occupancy probability grid and secondary signal data that does not indicate the presence of an obstacle at the second cell may decrease the occupancy probability of the second cell. Further, primary signal data that does not indicate the presence of an obstacle at the second cell may decrease the occupancy probability of the second cell. The amount of the decrease in the occupancy probability generated as a result of reception of the primary signal data may be scaled (larger or smaller) relative to the decrease generated as a result of the reception of the secondary signal data, such that the effect of the primary signal data is attenuated within the second occupancy probability grid.

The master occupancy grid may comprise a plurality of cells having a same or similar number of cells as the first and/or second occupancy probability grids, such that the locations associated with the cells of the master occupancy grid correspond to the locations of the cells of the first and/or second occupancy probability grids. The occupancy probability of the plurality of cells within the master occupancy grid may be set to the greater of the occupancy value within the first and second occupancy probability grids. For example, the occupancy probability of a third cell within the master occupancy grid may be set to the greater of the occupancy probability of the first cell within the first occupancy grid and the second cell within the second occupancy grid.

The method may then include instructing the autonomous vehicle 100 (or one or more of the various vehicular sub-systems) to drive along a path through the operating environment based on the occupancy probability of the third cell. For example, the autonomous vehicle 100 may be instructed to drive along a path that does not contain the location associated with the third cell when the occupancy probability of the third cell is above a particular value. This may enable the autonomous vehicle to better detect obstacles and improve operational safety of the autonomous vehicle 100.

In yet another method for fusing the primary and secondary signal data, the autonomous vehicle 100 may rely on the primary signal data to the exclusion of the secondary signal data whenever the primary signal data and the secondary signal data conflict.

When the primary and secondary signal data both indicate the presence of an obstacle, the occupancy probability of the cell of the occupancy probability map may be increased and when the primary and secondary signal data both do not indicate the presence of an obstacle, the occupancy probability of the cell may be decreased. However, when the primary signal data indicates the presence of an obstacle at the cell and the secondary signal data does not indicate the presence of an obstacle at the cell, the primary signal data may be relied on to increase the occupancy probability of the cell. Similarly, when the primary signal data does not indicate the presence of an obstacle at the cell and the secondary signal data indicates the presence of an obstacle at the cell, the primary signal data may be relied on to decrease the occupancy probability of the cell.

Thus, the primary signal data may be preferentially relied on to set the occupancy probability of the cell. However, in some situations the secondary signal data may be relied on to the exclusion or despite conflict with the primary signal data. In one embodiment, the secondary signal data may be relied on to increase and/or decrease the occupancy probability of the cell (e.g., when the secondary signal data indicates or does not indicate the presence of an obstacle, respectively) when primary signal data associated with the location of the cell is not available. For example, the secondary sensor may collect secondary signal data over a location of the operating environment in which the primary sensor has not collected primary signal data. In such instances, the autonomous vehicle may rely on the secondary signal data to navigate the autonomous vehicle 100.

In another embodiment, the secondary signal data may be relied on to set the occupancy probability of the cell if the primary sensor has not collected signal data associated with the location of the cell within a time threshold. For example, the primary sensor may be positioned towards the front 102 of the autonomous vehicle 100 and the secondary sensor may be positioned towards the rear 104 of the autonomous vehicle 100. While the primary signal data may be principally relied on to set the occupancy probability of the cells associated with locations disposed in the front of the autonomous vehicle 100, the secondary signal data may be relied on to set the occupancy probability of cells associated with locations disposed behind the autonomous vehicle 100, particularly when the time since the primary sensor collected signal data associated with locations behind the autonomous vehicle 100 is above the time threshold.

For example, the secondary signal data may be relied on over the primary signal data when the autonomous vehicle is driven in reverse, such as during portions of a three-point turn or in situations when the autonomous vehicle cannot feasibly turn around and must drive in reverse for an extended period of time. The time threshold may be a length of time within a range of 0.1, 0.2, 0.3, 0.4, 0.5, 1, 1.5, 2, 2.5, 3, 4, or 5 seconds, or may be within a larger length of time, such as within a range of 5, 10, 15, 20, 30, 45, 60, 90, 120, 150, or 180 seconds, or may be within a range having any two of the foregoing as endpoints. Selecting signal data (e.g., primary or secondary signal data) on which to rely based on the time threshold may only apply based on a mode of operation of the autonomous vehicle. For example, the time threshold may only apply when the autonomous vehicle is driven in reverse.

To facilitate the above embodiments, the cell may comprise or otherwise store a label that indicates which signal data (e.g., primary or secondary) was used to set the occupancy probability of the cell. The label may indicate which signal data was last used to set the occupancy probability of the cell. The system may then identify newly received signal data and compare the type of signal data with that used to previously set the occupancy probability of the cell. For example, the label may indicate that primary signal data was used to previously set the occupancy probability of the cell such that subsequent adjustment of the occupancy probability may not be based on the secondary signal data.

Additionally, or alternatively, the cell may store or otherwise be associated with a timestamp indicating when the signal data used to set the occupancy probability of the cell was received. The system may then compare an elapsed time since the timestamp to a time threshold to determine when the autonomous vehicle 100 should begin to rely on the secondary signal data over the primary signal data. For example, if an elapsed time between the timestamp and the time the primary signal data is received is greater than a time threshold then the system may begin to rely on received secondary signal data over the primary signal data to navigate the autonomous vehicle 100.

In this manner, the secondary signal data may be used to confirm or validate the calculations and/or conclusions determined from the primary signal data but is not allowed to invalidate conflicting calculations and/or conclusions determined from the primary signal data unless an elapsed time since the primary signal data was collected is over a time threshold and thus no longer reliable. Thus, the autonomous vehicle system may be enabled to rely to a larger extent on the greater capability of the primary sensor than on the lesser capability of the secondary sensor.

The method may then include instructing the autonomous vehicle 100 (or one or more of the various vehicular sub-systems) to drive along a path through the operating environment based on the occupancy probability of the cell. For example, the autonomous vehicle 100 may be instructed to drive along a path that does not contain the location associated with the cell when the occupancy probability of the cell is above a particular value. This may enable the autonomous vehicle to better detect obstacles and improve operational safety of the autonomous vehicle 100.

While the above methods disclose increasing and decreasing the occupancy probability of cells based on detection of an obstacle 350 or lack thereof within the primary and/or secondary signal data, the methods described may comprise in addition, or alternatively, maintaining the occupancy probability at a current value or above an occupancy threshold when the signal data (primary or secondary, as appropriate) indicates the presence of an obstacle, or maintaining the occupancy probability at a current value or below an occupancy threshold when the signal data does not indicate the presence of an obstacle.

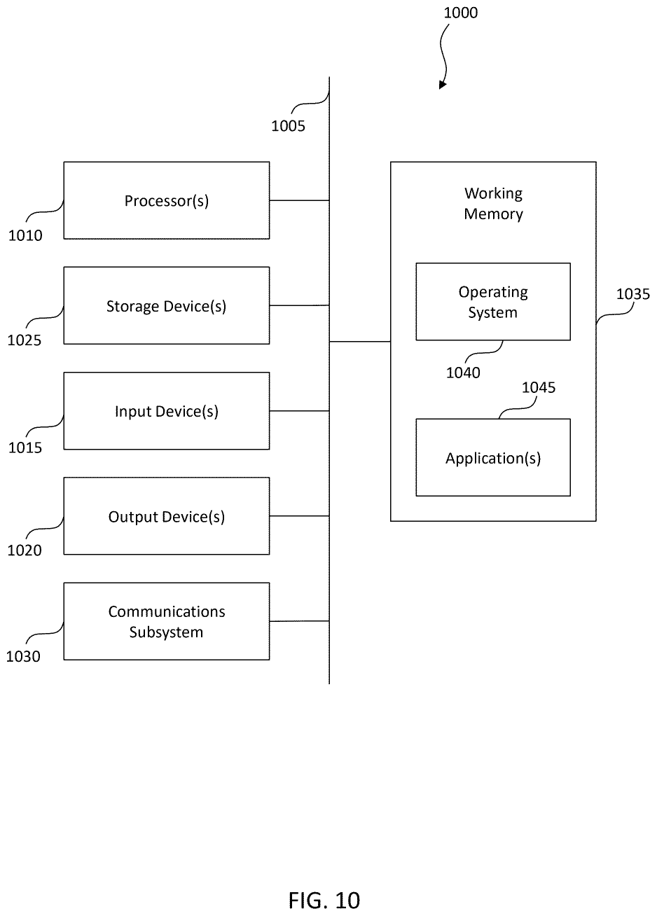

The computational system 1000, shown in FIG. 10, can be used to perform any of the embodiments of the invention. As another example, computational system 1000 can be used to perform any calculation, identification, and/or determination described herein. Computational system 1000 includes hardware elements that can be electrically coupled via a bus 1005 (or may otherwise be in communication, as appropriate). The hardware elements can include one or more processors 1010, including without limitation one or more general-purpose processors and/or one or more special-purpose processors (such as digital signal processing chips, graphics acceleration chips, and/or the like); one or more input devices 1015, which can include without limitation a mouse, a keyboard, and/or the like; and one or more output devices 1020, which can include without limitation a display device, a printer, and/or the like.

The computational system 1000 may further include (and/or be in communication with) one or more storage devices 1025, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable, and/or the like. The computational system 1000 might also include a communications subsystem 1030, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 1030 may permit data to be exchanged with a network (such as the network described below, to name one example), and/or any other devices described herein. In many embodiments, the computational system 1000 will further include a working memory 1035, which can include a RAM or ROM device, as described above.

The computational system 1000 also can include software elements, shown as being currently located within the working memory 1035, including an operating system 1040 and/or other code, such as one or more application programs 1045, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 1025 described above.

In some cases, the storage medium might be incorporated within the computational system 1000 or in communication with the computational system 1000. In other embodiments, the storage medium might be separate from a computational system 1000 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 1000 and/or might take the form of source and/or installable code, which, upon compilation and/or installation on the computational system 1000 (e.g., using any of a variety of generally available compilers, installation programs, compression/decompression utilities, etc.) then takes the form of executable code.

The computational system 1000 may be configured to operate an autonomous vehicle platform. The term “autonomous vehicle”, and related terms (e.g., “autonomous vehicle platform”), as used herein may include manned vehicles, remote control vehicles, and/or manual vehicles, etc. The autonomous vehicle platform may comprise a steering mechanism in communication with the processor, where the processor communicates steering commands to the steering mechanism based on the occupancy probability. The autonomous vehicle platform may comprise a braking mechanism in communication with the processor, where the processor communicates braking commands to the braking mechanism based on the occupancy probability.

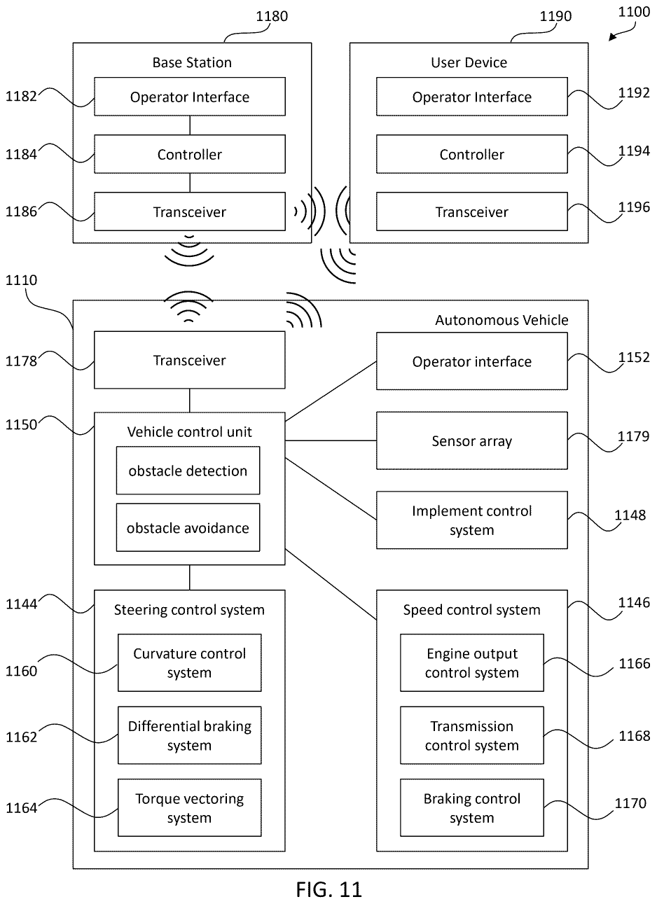

FIG. 11 is a block diagram of a communication and control system 1100 that may be utilized in conjunction with the systems and methods of the disclosure. The communication and control system 1100 may include a vehicle control unit 1150 which may be mounted on an autonomous vehicle 1110. The autonomous vehicle 1110, for example, may include a yard truck, loader, wheel loader, track loader, dump truck, digger, backhoe, forklift, mower (e.g., lawn, field, or brush mower), or other vehicle. The communication and control system 1100, for example, may include any or all components of computational system 1000 shown in FIG. 10.

For example, the autonomous vehicle 1110 may include a steering control system 1144 that may control a direction of movement of the autonomous vehicle 1110. The steering control system 1144, for example, may include any or all components of computational system 1000 shown in FIG. 10.

The autonomous vehicle 1110, for example, may include a speed control system 1146 that controls the speed, acceleration, and deceleration of the autonomous vehicle 1110. The speed control system 1146, for example, may control the speed of the autonomous vehicle 1110 based on map data, control algorithms, obstacle detection, start and/or stop points, input from the operator (e.g., a remote operator), etc. The speed control system 1146, for example, may include any or all components of computational system 1000 shown in FIG. 10.

The autonomous vehicle 1110, for example, may include an implement control system 1148 that may control operation of an implement towed by the autonomous vehicle 1110, integrated within the autonomous vehicle 1110, or coupled to the autonomous vehicle 1110. The implement control system 1148, for example, may include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, etc. The implement control system 1148, for example, may include any or all components of computational system 1000 shown in FIG. 10.

The vehicle control unit 1150 may be communicatively coupled with the steering control system 1144, the speed control system 1146, and/or the implement control system 1148. The vehicle control unit 1150, for example, may include any or all of the components shown in FIG. 10. The vehicle control unit 1150, for example, may be integrated into a single controller or may include a plurality of distinct components or controllers. The vehicle control unit 1150 may also be coupled with one or more sensors from the sensor array 1179 and receive signal data from the sensor array 1179.

The vehicle control unit 1150, for example, may be used to control various aspects of the autonomous vehicle 1110 such as, for example, sending instructions to the steering control system 1144, implement control system 1148, speed control system 1146, etc. The vehicle control unit 1150, for example, may include a vehicle artificial intelligence (VAI) that may include one or more processors that execute one or more algorithms, including the methods disclosed above.

The vehicle control unit 1150, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensor array 1179 or from a base station 1180 (described below).

The vehicle control unit 1150, for example, may be an electronic controller with electrical circuitry configured to process data from the various components of the autonomous vehicle 1110. The vehicle control unit 1150 may include a processor, such as the processor 1010, and a working memory 1035. The vehicle control unit 1150 may also include one or more storage devices, storage media, and/or other suitable components of computational system 1000. The processor may be used to execute software, such as software for calculating drivable path plans. Moreover, the processor may include multiple microprocessors, one or more “general-purpose” microprocessors, one or more special-purpose microprocessors, and/or one or more application specific integrated circuits (ASICS), or any combination thereof. For example, the processor may include one or more reduced instruction set (RISC) processors. The vehicle control unit 1150, for example, may include any or all the components shown in FIG. 10.

The vehicle control unit 1150, for example, may include a volatile memory, such as random access memory (RAM), and/or a nonvolatile memory, such as ROM (e.g., working memory 1035, storage device 1025, and/or other computer-readable media). The memory may store a variety of information and may be used for various purposes. For example, the memory may store processor-executable instructions (e.g., firmware or software) for the vehicle control unit 1150 to execute, such as instructions for calculating a drivable path plan, and/or controlling the autonomous vehicle 1110 (e.g., for implementing the methods describe above). The memory may include flash memory, one or more hard drives, or any other suitable optical, magnetic, or solid-state storage medium, or a combination thereof. The memory may store data such as field maps, maps of desired paths, vehicle characteristics, software or firmware instructions, and/or any other suitable data.

The steering control system 1144, for example, may include a curvature rate control system 1160, a differential braking system 1162, a steering mechanism, and a torque vectoring system 1164 that may be used to steer the autonomous vehicle 1110. The curvature rate control system 1160, for example, may control a direction of an autonomous vehicle 1110 by controlling a steering control system of the autonomous vehicle 1110 with a curvature rate, such as an Ackerman style autonomous vehicle, 1110 or articulating vehicle. The curvature rate control system 1160, for example, may automatically rotate one or more wheels or tracks of the autonomous vehicle 1110 via hydraulic or electric actuators to steer the autonomous vehicle 1110. By way of example, the curvature rate control system 1160 may rotate front wheels/tracks, rear wheels/tracks, and/or intermediate wheels/tracks of the autonomous vehicle 1110 or articulate the frame of the vehicle, either individually or in groups. The differential braking system 1162 may independently vary the braking force on each lateral side of the autonomous vehicle 1110 to direct the autonomous vehicle 1110. Similarly, the torque vectoring system 1164 may differentially apply torque from the engine to the wheels and/or tracks on each lateral side of the autonomous vehicle 1110. While the illustrated steering control system 1144 includes the curvature rate control system 1160, the differential braking system 1162, and the torque vectoring system 1164, the steering control system 1144 may include one or more of these systems. Further examples may include a steering control system 1144 having other and/or additional systems to facilitate turning the autonomous vehicle 1110 such as an articulated steering control system, a differential drive system, and the like.

The speed control system 1146, for example, may include an engine output control system 1166, a transmission control system 1168, and a braking control system 1170. The engine output control system 1166 may vary the output of the engine to control the speed of the autonomous vehicle 1110. For example, the engine output control system 1166 may vary a throttle setting of the engine, a fuel/air mixture of the engine, a timing of the engine, and/or other suitable engine parameters to control engine output. In addition, the transmission control system 1168 may adjust gear selection within a transmission to control the speed of the autonomous vehicle 1110. Furthermore, the braking control system 1170 may adjust the braking force to control the speed of the autonomous vehicle 1110. While the illustrated speed control system 1146 includes the engine output control system 1166, the transmission control system 1168, and the braking control system 1170, the speed control system 1146 may include one or two of these systems. The speed control system 1146, for example, may also include other systems and/or additional systems that may be used to control the speed of the autonomous vehicle 1110.

The implement control system 1148, for example, may control various parameters of the implement towed by and/or integrated within the autonomous vehicle 1110. For example, the implement control system 1148 may instruct an implement controller via a communication link, such as a CAN bus, ISOBUS, Ethernet, wireless communications, and/or Broad R Reach type Automotive Ethernet, etc.

The implement control system 1148, for example, may instruct an implement controller to adjust a penetration depth of at least one ground engaging tool of an agricultural implement, which may reduce the draft load on the autonomous vehicle 1110.

The implement control system 1148, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc. The implement control system 1148, as another example, may instruct the implement controller to adjust a shovel height, a shovel angle, a shovel position, etc.

The communication and control system 1100, for example, may include a sensor array 1179. The sensor array 1179, for example, may facilitate determination of condition(s) of the autonomous vehicle 1110 and/or the work area. For example, the sensor array 1179 may include one or more sensors (e.g., infrared sensors, ultrasonic sensors, magnetic sensors, tachometer, radar sensors, LiDAR sensors, terahertz sensors, sonar sensors, wheel encoders, cameras, etc.) that monitor a rotation rate of a respective wheel and/or track a ground speed of the autonomous vehicle 1110. The sensors may also monitor operating levels (e.g., temperature, fuel level, etc.) of the autonomous vehicle 1110. Furthermore, the sensors may monitor conditions in and around the work area, such as temperature, weather, wind speed, compass, humidity, and other conditions. The sensors of the sensor array 1179, for example, may detect physical objects in the work area, such as a parking stall, a material stall, accessories, other vehicles, obstacles, environmental features, or other object(s) that may be in the area surrounding the autonomous vehicle 1110.

The sensor array 1179, for example, may include a velocity sensor which may include one or more of an inertial measurement unit, a compass, a GPS sensor, a wheel encoder, a tachometer, a camera, a radar, etc. The sensor array 1179, for example, may also include a steering angle sensor. The velocity sensor, for example, may produce velocity data. Velocity data may include information regarding speed and/or bearing. Velocity data, for example, may additionally, or alternatively, include information regarding the steering angular rate.

The autonomous vehicle 1110 may include an operator interface 1152 for controlling the vehicle. The operator interface 1152, for example, may be communicatively coupled to the vehicle control unit 1150 and configured to present data from the autonomous vehicle 1110 via a display. Display data may include data associated with operation of the autonomous vehicle 1110, data associated with operation of an implement, a position of the autonomous vehicle 1110, a speed of the autonomous vehicle 1110, a desired path, a drivable path plan, a target position, and/or a current position, etc. The operator interface 1152 may enable an operator to control certain functions of the autonomous vehicle 1110 such as starting and stopping the autonomous vehicle 1110, inputting a desired path, etc. The operator interface 1152, for example, may enable the operator to input parameters that cause the vehicle control unit 1150 to adjust the drivable path plan. For example, the operator may provide an input requesting that the desired path be acquired as quickly as possible, that an off-path normal error be minimized, that a speed of the autonomous vehicle 1110 remain within certain limits, and/or that a lateral acceleration experienced by the autonomous vehicle 1110 remain within certain limits, etc. In addition, the operator interface 1152 (e.g., via the display, or via an audio system (not shown), etc.) may alert an operator if the desired path cannot be achieved, for example.

The communication and control system 1100, for example, may include a base station 1180 having a base station controller 1184 located remotely from the autonomous vehicle 1110. For example, the control functions of the vehicle control unit 1150 may be distributed between the vehicle control unit 1150 of the autonomous vehicle 1110 and the base station controller 1184. The base station controller 1184, for example, may perform a substantial portion of the control functions of the vehicle control unit 1150. For example, a first transceiver 1178 positioned on the autonomous vehicle 1110 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 1186 at the base station 1180. The base station controller 1184, for example, may calculate drivable path plans and/or output control signals to control the curvature control system 1160, the speed control system 1146, and/or the implement control system 1148 to direct the autonomous vehicle 1110 toward the desired path, for example. The base station controller 1184 may include a processor and memory device having similar features and/or capabilities as the processor and the memory device discussed previously. Likewise, the base station 1180 may include an operator interface 1182 having a display, which may have similar features and/or capabilities as the operator interface 1152 and the display discussed previously.

In some embodiments, one or both of the base station 1180 and/or the autonomous vehicle 1110 may be in communication with a user device 1190. A user device 1190 may include a phone, tablet, laptop, or computer. The user device 1190 may similarly include an operator interface 1192 which may include similar features and capabilities as operator interfaces 1152, 1182 described above. Additionally, or alternatively, the user device 1190 may comprise a controller 1194 that may include the same or similar features, components, and/or characteristics as the controller 1184 of the base station 1180. For example, the user device controller 1184 may calculate drivable path plans, output control signals to control the curvature control system 1160, the speed control system 1146, and/or the implement control system 1148 to direct the autonomous vehicle 1110. The user device 1190, for example, can include an application that allows the user (e.g., a remote operator) to communicate commands to the autonomous vehicle 1110 (e.g., via a transceiver 1196) and/or receive information about the autonomous vehicle 1110. Alternatively, or additionally, the user device 1190, for example, can include an application that allows the operator to observe the autonomous vehicle 1110 move through a map of the work area where the autonomous vehicle operates.

The user device 1190, for example, may include an application that can receive an indication associated with the remote operator or which can receive other user or operator inputs. The user device 1190, for example, may include an application that can display any of the information disclosed in this document.

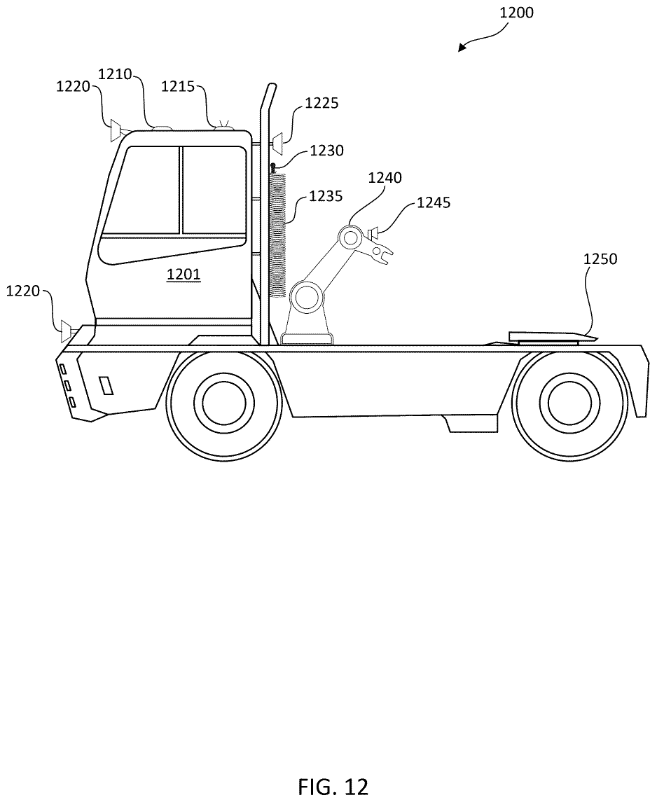

FIG. 12 is a side view of an autonomous yard truck 1200 according to some embodiments. The autonomous yard truck 1200 includes a cab 1201 that may be used to drive the autonomous yard truck 1200 manually. The autonomous yard truck 1200 may include one or more of the components shown in FIG. 11. The autonomous yard truck 1200 may also include a brake system, an engine, a transmission, steering, sensor array, etc. such as, for example, as shown in FIG. 11.

In some embodiments, the autonomous yard truck 1200 may include a sensor array that includes sensors 1220 (e.g., sensor array 1179) disposed at various locations on the autonomous yard truck 1200 such as, for example, on the cab 1201, bumper, housing, frame, etc. The sensors 1220 may include infrared sensors, ultrasonic sensors, magnetic sensors, radar sensors, LiDAR sensors, terahertz sensors, sonar sensors, cameras, etc. The autonomous yard truck 1200 may also include one or more backup sensors 1225 such as, for example, infrared sensors, ultrasonic sensors, magnetic sensors, radar sensors, LiDAR sensors, terahertz sensors, sonar sensors, cameras, etc.

In some embodiments, the autonomous yard truck 1200 may include a spatial locating device (or GPS) antenna 1210. In some embodiments, the autonomous yard truck 1200 may include a transceiver antenna 1215.

In some embodiments, the autonomous yard truck 1200 may include one or more hoses 1235 that can connect with a trailer such as, for example, two or three hoses. Each hose may have a hose connector 1230 that can connect with a trailer hose connector. For example, the one or more hoses 1235 of the autonomous yard truck 1200 may include a service brake hose, an emergency brake hose, and/or a refrigerant hose.

In some embodiments, the autonomous yard truck 1200 may include a robotic arm 1240 disposed on the back bed of the autonomous yard truck 1200. The robotic arm 1240 may include any type of robotic arm. The robotic arm 1240, for example, may exert high torque or high pressure sufficient to connect the hose connector 1230 with the trailer hose connector. The hose connector 1230 and/or the trailer hose connector may comprise a glad-hand connector. In some embodiments, when the autonomous yard truck 1200 is not coupled with a trailer, the hose connector 1230 may be positioned in a storage rack at some point on the autonomous yard truck 1200 such as, for example, on the rear of the cab 1201.

In some embodiments, the robotic arm 1240 may include one or more arm sensors 1245 such as, for example, infrared sensors, ultrasonic sensors, magnetic sensors, radar sensors, LiDAR sensors, terahertz sensors, sonar sensors, cameras, etc. The arm sensor 1245, for example, may produce data that can be used to identify the location of a hose connector 1230 and/or a trailer hose connector. The arm sensor 1245, for example, may produce data that can show that a hose connector 1230 and/or a trailer hose connector are sufficiently coupled.

In some embodiments, the autonomous yard truck 1200 may include a fifth-wheel coupling 1250. The fifth-wheel coupling 1250, for example, may be raised or lowered with a fifth-wheel coupling boom. FIG. 12 shows the fifth-wheel coupling 1250 in a lowered position. The fifth-wheel coupling 1250 may couple with a kingpin of a trailer.

When the fifth-wheel coupling 1250 is coupled with a kingpin and the fifth-wheel coupling 1250 is in the raised position, the legs of the trailer may lift off the ground (e.g., automatically). This may allow the autonomous yard truck 1200 to pull the trailer without individually raising the trailer legs.

In some embodiments, the robotic arm 1240 and/or the arm sensor 1245 may be coupled with a thermal management system. A thermal management system may, for example, be coupled with a thermal management system associated with the autonomous yard truck 1200 such as, for example, coupled with the cab heating/cooling system and/or the engine heating/cooling system. A thermal management system may, for example, be an independent system that heats and/or cools the robotic arm 1240 and/or the arm sensor 1245. A thermal management system may, for example, keep the temperature of the robotic arm 1240 and/or the arm sensor 1245 between about 32° F. and about 100° F.

In some embodiments, the autonomous yard truck 1200 may include a deployable shade coupled with the back of the cab 1201. The deployable shade, for example, may be used to screen the sun and/or other lighting from the arm sensor 1245 and/or the one or more backup sensors 1225. The deployable shade, for example, may include an umbrella configuration or an awning configuration. The deployable shade, for example, may be coupled with the roof or an upper portion of the cab.

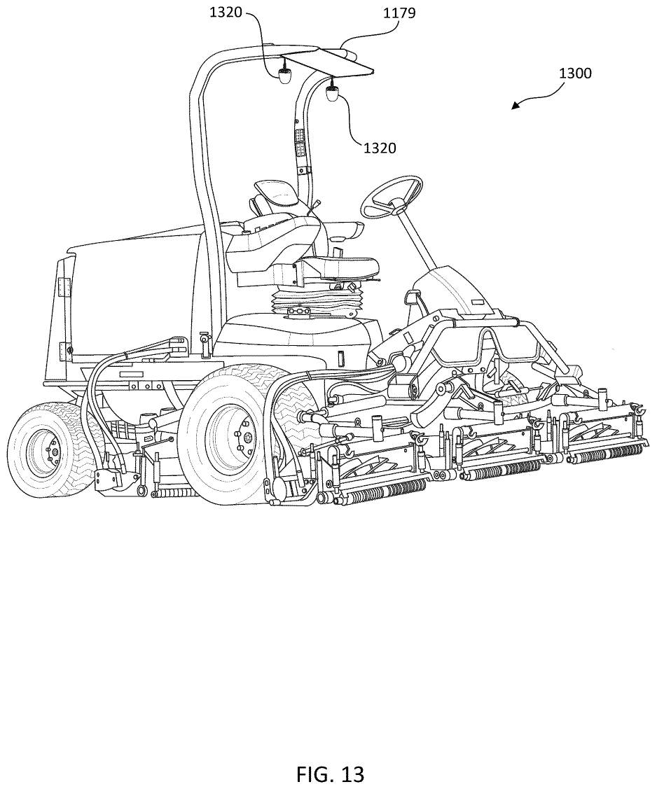

FIG. 13 is a sideview of an example autonomous mower 1300, which may include all or some of the components of autonomous vehicle 1110. The autonomous vehicle in this document may include the autonomous mower 1300. Any type of mower or blades may be used, such as a disc mower. The autonomous mower 1300, for example, may include a sensor array 1179 (or multiple sensor arrays 1179), including sensors 1320. The sensor array 1179 may include, for example, one or more LiDAR, radar, and/or video cameras. The video cameras, for example, may include 360 degree cameras, a front facing camera, and/or a back facing camera.

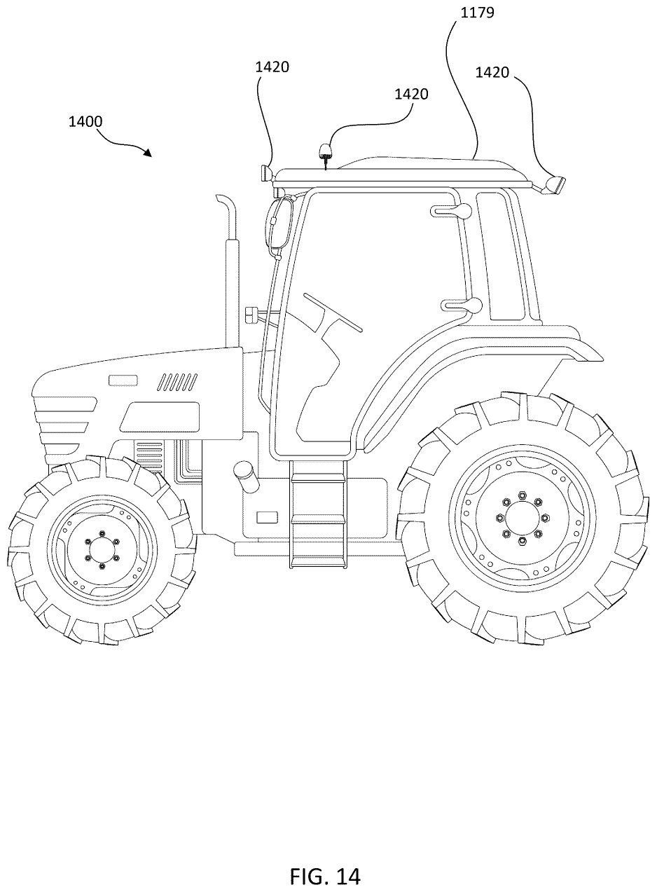

FIG. 14 is a sideview of an example autonomous tractor 1400, which may include all or some of the components of autonomous vehicle 1110. The autonomous vehicle in this document may include the autonomous tractor 1400. In this example, the autonomous tractor 1400 may include standard tractor equipment and/or components. The autonomous tractor 1400 may include or be coupled with any kind of implement such as, for example, a plow, disc plow, reel mower, dumper, lift, bucket, shovel, blade, and/or cutter, etc. The autonomous tractor 1400, for example, may include a sensor array 1179 (or multiple sensor arrays 1179), including sensor(s) 1420. The sensor array 1179 may include, for example, one or more LiDAR, radar, and/or video cameras. The video cameras, for example, may include 360 degree cameras, a front facing camera, and/or a back facing camera.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied - for example, blocks can be re-ordered, combined, and/or broken into sub-blocks. Certain blocks or processes can be performed in parallel.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The terms “first”, “second”, “third”, etc. are used to distinguish respective elements and are not used to denote a particular order of those elements unless otherwise specified or order is explicitly described or required.

The conjunction “or” is inclusive.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. An autonomous vehicle comprising:
a steering control system;
a speed control system;
one or more sensors, including a primary sensor and a secondary sensor;
one or more processors communicatively coupled with the one or more sensors, the steering control system, and the speed control system; and
one or more computer-readable media having stored thereon instructions that when executed by the one or more processors:
receive primary signal data from the primary sensor;
receive secondary signal data from the secondary sensor;
calculate an occupancy probability of a cell of a plurality of cells within an occupancy probability map based on the primary signal data and the secondary signal data, wherein the occupancy probability map represents a sensor field of view within an operating environment, such that:
when the primary signal data indicate presence of an obstacle at the cell, increasing the occupancy probability of the cell;
when the secondary signal data indicate presence of an obstacle at the cell, increasing the occupancy probability of the cell;
when the primary signal data does not indicate presence of an obstacle at the cell, decreasing the occupancy probability of the cell; and
when the secondary signal data does not indicate presence of an obstacle at the cell, not decreasing the occupancy probability of the cell; and
instruct the steering control system and the speed control system to drive the autonomous vehicle along a path through an area in the operating environment based on the occupancy probability of the cell.

2. The autonomous vehicle of claim 1, wherein the primary sensor has greater detection capability than the secondary sensor.

3. The autonomous vehicle of claim 1, wherein the primary sensor is a 3D LiDAR sensor and wherein the secondary sensor is a 2D LiDAR sensor.

4. The autonomous vehicle of claim 1, wherein the primary sensor is positioned at a front of the autonomous vehicle and the secondary sensor is positioned at a side or rear of the autonomous vehicle.

5. The autonomous vehicle of claim 1, wherein the autonomous vehicle comprises two, three, four, five, six, seven, eight, or more than eight secondary sensors.

6. The autonomous vehicle of claim 1, wherein the primary sensor and the secondary sensor have overlapping fields of view.

7. The autonomous vehicle of claim 1, wherein the secondary sensor is positioned towards a bottom of the autonomous vehicle relative to the primary sensor.

8. The autonomous vehicle of claim 1, wherein one of the one or more sensors comprises a LiDAR, depth camera, structure light camera, a stereo camera, or a radar.

9. The autonomous vehicle of claim 1, further comprising a steering mechanism in communication with the one or more processors, wherein the one or more processors communicate steering commands to the steering mechanism based on an occupancy probability of the cell.

10. The autonomous vehicle of claim 1, further comprising a braking mechanism in communication with the one or more processors, wherein the one or more processors communicate braking commands to the braking mechanism based on an occupancy probability of the cell.

11. A method comprising:
receive primary signal data from a primary sensor;
receive secondary signal data from a secondary sensor;
calculate an occupancy probability of a cell of a plurality of cells within an occupancy probability map based on the primary signal data and the secondary signal data, wherein the occupancy probability map represents a sensor field of view within an operating environment, such that:
when the primary signal data indicate presence of an obstacle at the cell, increasing the occupancy probability of the cell;
when the secondary signal data indicate presence of an obstacle at the cell, increasing the occupancy probability of the cell;
when the primary signal data does not indicate presence of an obstacle at the cell, decreasing the occupancy probability of the cell; and
when the secondary signal data does not indicate presence of an obstacle at the cell, not decreasing the occupancy probability of the cell; and
instruct a steering control system and a speed control system to drive an autonomous vehicle along a path through an area in the operating environment based on the occupancy probability of the cell.

12. The method of claim 11, wherein the primary sensor has greater detection capability than the secondary sensor.

13. The method of claim 11, wherein the primary sensor is a 3D LiDAR sensor and wherein the secondary sensor is a 2D LiDAR sensor.

14. The method of claim 11, wherein the primary sensor is positioned at a front of the autonomous vehicle and the secondary sensor is positioned at a side or rear of the autonomous vehicle.

15. The method of claim 11, wherein the autonomous vehicle comprises two, three, four, five, six, seven, eight, or more than eight secondary sensors.

16. The method of claim 11, wherein the primary sensor and the secondary sensor have overlapping fields of view.

17. The method of claim 11, wherein the secondary sensor is positioned towards a bottom of the autonomous vehicle relative to the primary sensor.

18. An autonomous vehicle comprising:
a steering control system;
a speed control system;
one or more sensors, including a primary sensor and a secondary sensor;
one or more processors communicatively coupled with the one or more sensors, the steering control system, and the speed control system; and
one or more computer-readable media having stored thereon instructions that when executed by the one or more processors:
receive primary signal data from the primary sensor;
receive secondary signal data from the secondary sensor;
when the secondary signal data conflicts with the primary signal data, calculate an occupancy probability of a cell of a plurality of cells within an occupancy probability map, wherein the occupancy probability map represents a sensor field of view within an operating environment, based on the primary signal data but not the secondary signal data; and
instruct the steering control system and the speed control system to drive the autonomous vehicle along a path through an area in the operating environment based on the occupancy probability of the cell.

19. The autonomous vehicle of claim 18, wherein the primary sensor is a 3D LiDAR sensor and wherein the secondary sensor is a 2D LiDAR sensor.

20. The autonomous vehicle of claim 18, wherein calculating the occupancy probability is based on the secondary signal data and not the primary signal data when the vehicle is driven in reverse.
